(19) United States
(12) Patent Application Publication
(10) Pub. No.: US 2012/0112026 A1
(43) Pub. Date: May 10, 2012

(54) APPARATUS FOR SUPPORTING AN ASSEMBLY OF CONFLAT-CONNECTED ULTRA-HIGH VACUUM MODULES

(75) Inventor: Charles K. Crawford, Wilton, NH (US)

(73) Assignee: KIMBALL PHYSICS, INC., Wilton, NH (US)

(21) Appl. No.: 13/292,375

(22) Filed: Nov. 9, 2011

Related U.S. Application Data
(60) Provisional application No. 61/412,208, filed on Nov. 10, 2010.

(51) Int. Cl. F16M 13/00; F16B 2/06

(52) U.S. Cl. 248/316.1; 248/309.1

(57) ABSTRACT

An apparatus for supporting UHV modules and attaching accessories thereto without welding and without obstructing any conflat ports includes a bracket attachable to an attachment feature without loss of vacuum. Embodiments permit arbitrary UHV module reorientation. In some embodiments, a supporting circular groove or series of groove segments is provided in the UHV module, and a clamping bracket fitted with holes meeting optical bench standards is attached to the groove by clamping two clamp segments together while fitting a tongue firmly into the groove. The supporting groove can be located in an extension terminating in a conflat flange, or in a separate UHV extender module. In other embodiments, the attachment feature is a plurality of threaded mounting holes that are not associated with conflat ports, do not require enlargement of the UHV module, and permit attachment of brackets without obstructing any conflat ports and without loss of vacuum.

### RELATED APPLICATIONS

This application claims the benefit of U.S. Provisional Application No. 61/412,208, filed Nov. 10, 2010 and is herein incorporated by reference in its entirety for all purposes.

### FIELD OF THE INVENTION

The invention relates to ultra-high vacuum systems, and more particularly to apparatus and methods for supporting the weight of ultra-high vacuum systems.

### BACKGROUND OF THE INVENTION

Ultra-high vacuum systems find wide applications in research, education, product development, and production. Typical systems are comprised of independent and interchangeable ultra-high vacuum (UHV) components or modules, such as testing chambers, pumps, gauges, valves, specimen holders, electron sources, ion sources, photon sources, molecular beam sources, detectors of various types, and such like.

Processes or experiments that require high or ultra-high vacuum (UHV) currently employ all-metal vacuum joints formed by joining two vacuum ports to each other. A typical all-metal vacuum port, referred to herein as a “conflat” port, such as that described in U.S. Pat. No. 3,208,758, is illustrated in FIG. 1. Conflat ports include an annular joining region 20 surrounding an annular recess 26 and an annular knife edge 30. For some conflat ports, the annular joining region is a “conflat” flange 20 which provides tapped or clearance holes through which bolts can be inserted. Other conflat ports include a joining region with tapped holes bored directly into the body of the UHV module itself, so that the joining region is substantially flush with the body of the UHV module.

FIGS. 1 and 2 are perspective and cross-sectional side views respectively of an example of a conflat port having a conflat flange 20. With reference to FIG. 2, the conflat flange 20 is shown mated with another, similar flange 24 to form a conflat joint, the two flanges 20, 24 being separated by a soft, metallic gasket 34, which is usually made of copper. The opposing knife edges 30, 32 are pressed into the copper gasket 34 by tightening bolts 38, thereby forming the UHV seal of the conflat joint.

Many UHV applications require that a plurality of UHV modules be connected together by conflat joints into a single, large UHV system. Some UHV modules are approximately cubical or spherical, while others are more tubular, and may extend over a length which significantly exceeds their diameter. Many UHV modules are heavy, such that their weight must be properly supported so as to avoid applying undue torque to any of the conflat joints and risking a possible leak.

One typical approach to supporting the weight of UHV modules in a UHV system is to weld support flanges or struts to some of the UHV modules, and then to attach the support flanges or struts to an appropriate supporting platform. However, this requires on-site modification of the UHV modules using special welding equipment and skills, and results in permanent modifications to the UHV modules that cannot be easily removed or adjusted. In particular, such a welding approach typically provides support only at a fixed orientation of a UHV module, and does not allow for rotational adjustment and matching of the orientations of the UHV modules as they are assembled.

Another typical approach to supporting the weight of UHV modules in a UHV system is to attach support members to unused conflat ports in the system. In this approach, each support member is welded or otherwise permanently attached to a blank conflat flange that can be attached to an otherwise unused conflat port of the UHV module. This approach provides a reversible solution that requires no special equipment, and that can be rotated between a limited number of fixed orientations according to the pattern of bolt holes included in the conflat port. However, this approach necessarily requires that a sufficient number of otherwise unused conflat ports be available for attachment of supporting struts. And once the supports are assembled to the system, they cannot be removed or adjusted without loss of the vacuum within the system, which typically requires a time consuming re-sealing and re-pumping process afterward.

Yet another approach to supporting the weight of UHV modules in a UHV system is to remove at least one bolt from a conflat joint and attach a mounting strut or bracket to the exterior of the joint by passing a longer bolt or bolts through the strut and through the conflat joint. However, this approach tends to disturb the uniformity of the pressure which compresses the conflat joint and forms the UHV seal, thereby risking a vacuum leak. Also, this approach can cause the strut or bracket to apply a torque to the conflat joint, thereby risking a vacuum leak.

What is needed, therefore, is an apparatus for supporting the weight of a UHV module in a UHV system, wherein the apparatus does not require on-site modification of the UHV module, does not use, obstruct, or disturb any conflat ports, and enables attachment and detachment of the supporting apparatus, and reorientation of the UHV module about arbitrary angles relative to the supporting apparatus, without loss of vacuum.

### SUMMARY OF THE INVENTION

The present invention is an apparatus for supporting the weight of a UHV module in a UHV system without on-site modification of the UHV module, and without using, obstructing, or disturbing any conflat ports. The invention enables attachment and detachment of the supporting apparatus without loss of vacuum. Embodiments also permit reorientation of the UHV module about arbitrary angles relative to the supporting apparatus without loss of vacuum. The apparatus of the present invention includes an attachment feature included in the UHV module at the time of its manufacture, and a bracket that is attachable to the attachment feature without loss of vacuum and without using or blocking any conflat ports.

In one general aspect of the present invention, the attachment feature is a supporting groove formed in a UHV module in a circular pattern, the groove being compatible with a clamping bracket having a corresponding circular tongue that fits firmly into the groove so as to attach the bracket firmly to the UHV module. In various embodiments, the groove is broken into a series of supporting groove segments. It should be noted that the terms “groove” and “supporting groove” are used generically herein to refer to both a single groove and to a series of aligned groove segments, unless otherwise specified. In some embodiments, an angular orientation of the UHV module can be adjusted over a continuously selectable angle by loosening the attached clamping bracket and rotating the groove (or groove segments) relative to the bracket.

In some embodiments, the supporting groove surrounds an extension which joins a conflat flange to the body of the UHV module, and in other embodiments the supporting groove is in an adaptor UHV module that attaches to and extends a conflat port of the UHV module, so that there is no reduction in the number of available conflat ports. In various embodiments, the supporting groove is also compatible with brackets which clamp adjoining UHV modules together.

In certain embodiments, the supporting groove is formed directly in the body of the UHV module, and does not surround an extension or flange, although it may surround a conflat port.

In another general aspect of the present invention, the attachment feature is a plurality of threaded mounting holes that are not associated with conflat ports, the mounting holes being located so as to permit bolting of brackets to the holes without obstructing any conflat ports, and without loss of vacuum.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a perspective drawing of a conflat flange of the prior art;

FIG. 2 is a side cross-sectional partial view of a pair of the prior art conflat flanges of FIG. 1 bolted to each other;

FIG. 3 is a perspective drawing of a UHV module having two conflat ports that are surrounded by pluralities of support groove segments in an embodiment of the present invention;

FIG. 4 is a perspective view of an adaptor UHV module that is configured to extend a conflat port, and that includes a plurality of support groove segments, the adaptor module being shown in relation to a clamping bracket of an embodiment of the present invention;

FIG. 5 is a perspective view of a UHV module having a pair of the adaptor UHV modules attached to opposing conflat ports thereof, the UHV module being supported by a pair of clamping brackets attached to the support groove segments of the adaptor UHV modules, the clamping brackets being bolted to an optical bench;

FIG. 6A is a perspective view of a UHV system that includes a plurality of UHV modules joined to each other by conflat joints, the UHV system being supported by a pair of clamping brackets attached to a pair of support grooves, each of which is associated with one of the conflat ports;

FIG. 6B is an end view of the system of FIG. 6A;

FIG. 6C is a side view of the system of FIG. 6A;

FIG. 7A is a perspective view of a UHV module having a support groove formed in a spherical UHV module in a location which surrounds a conflat port;

FIG. 7B is a perspective view of the UHV module of FIG. 7A showing a clamping bracket attached to the support groove;

FIG. 8A is a detailed front drawing of a clamping bracket similar to the bracket of FIG. 4;

FIG. 8B is a detailed side split view drawing of the bracket of FIG. 8A;

FIGS. 8C through 8H are detailed front and side split view drawings of three other embodiments of clamping brackets;

FIG. 9 is a perspective view of the UHV module of FIG. 5, showing a support bracket attached to mounting holes provided in the top of the UHV module; and

FIG. 10 is a perspective view of a UHV module formed in the shape of two adjoining spheres, the UHV module having a pair of mounting holes on its side.

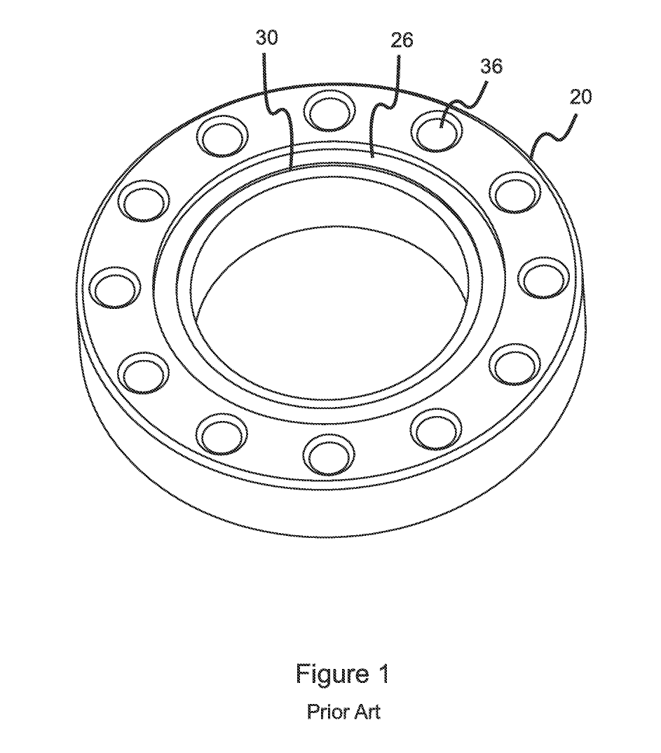

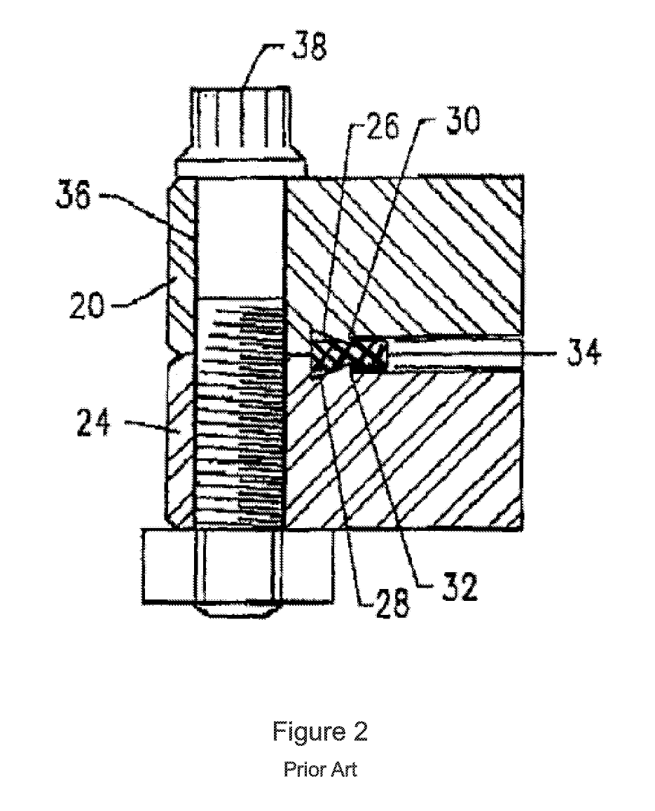

### DETAILED DESCRIPTION

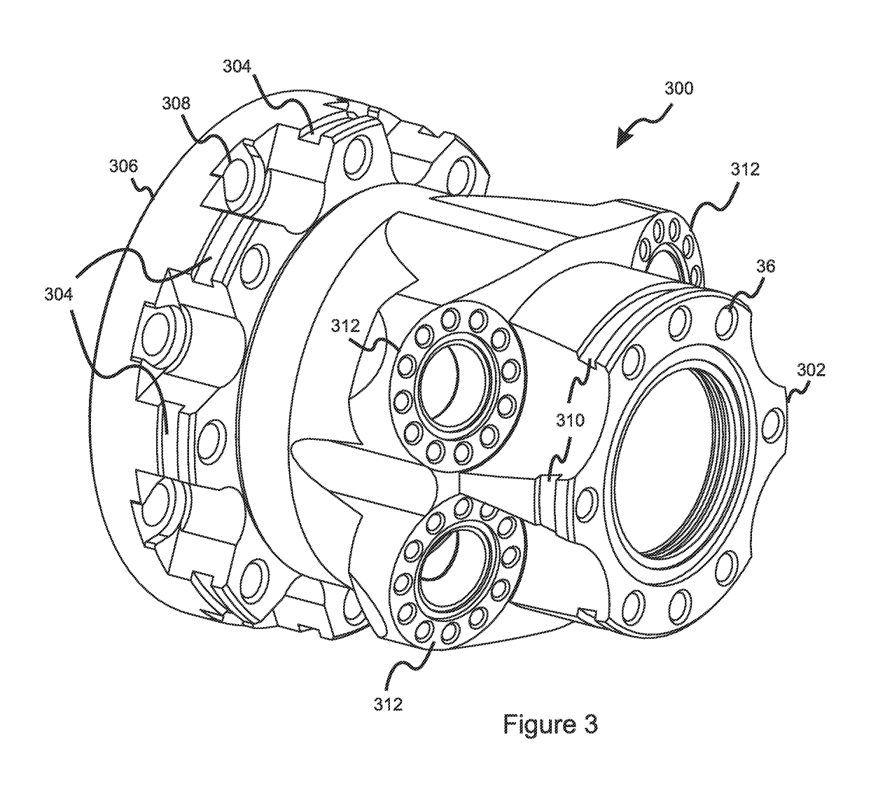

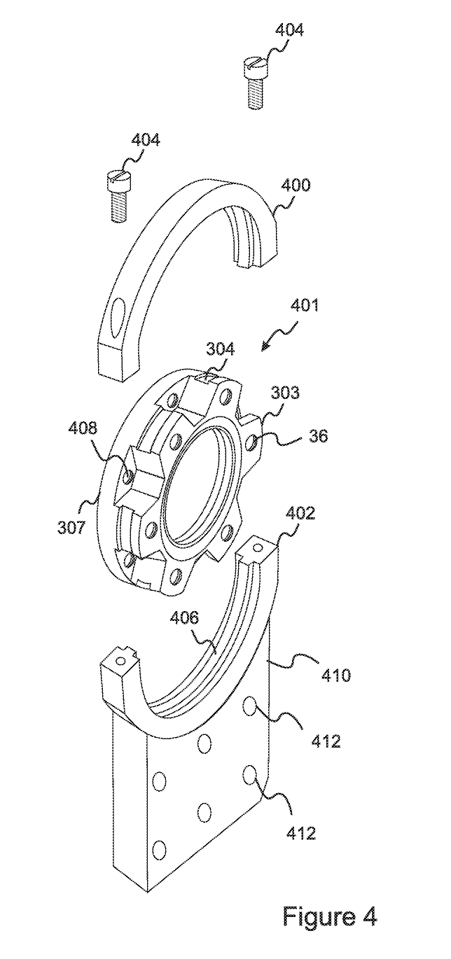

With reference to FIG. 3 and FIG. 4, the present invention is an apparatus for supporting the weight of a UHV module 300 in a UHV system without on-site modification of the UHV module 300, and without using or obstructing any conflat ports 302. The apparatus includes an attachment feature 304 included in the UHV module 300 at the time of its manufacture, and a bracket 400, 402 which is attachable to the attachment feature 304 without loss of vacuum and without using or blocking any conflat ports.

In one general aspect of the present invention, the attachment feature is a groove or a series of groove segments 304 into which tongue features 406 of the mounting bracket 400, 402 can be firmly inserted and clamped so as to attach the mounting bracket 400, 402 to the UHV module 300. The UHV module 300 illustrated in FIG. 3 includes a plurality of conflat ports. One of the conflat ports includes a flange 306 with clearance holes 308 through which mounting bolts can be inserted. An attachment feature proximal to this conflat port is a series of equally spaced, equally sized grooves 304 shaped as arcs aligned about a common circle, whereby the gaps between the arcs provide access for bolts to enter the clearance holes 308.

Another conflat port 302 in the UHV module 300 of FIG. 3 includes tapped holes 36 for threading therein of mounting bolts. An attachment feature proximal to this conflat port 302 is a series grooves 310 shaped as arcs of unequal sizes and unequal spacing aligned about a common circle, whereby the gaps between the segments provide access to additional conflat ports 312 included in the UHV module 300.

FIG. 4 illustrates a UHV adaptor module 401 that includes a pair of closely adjacent opposing conflat ports 303, 307 separated by a short segment in which are formed a series of supporting grooves segments 304. The supporting groove segments 304 are separated by gaps that provide space for bolts to enter bolt holes 408 so as to bolt one of the conflat ports 307 of the UHV adaptor module 401 to a conflat port of a UHV module. The other conflat port 303 is then available for attachment of a second UHV module, so that the number of available conflat ports is not reduced by attachment of the UHV adaptor module 401 to the UHV module.

The adaptor module 401is shown in FIG. 4 in relationship to a disassembled clamping bracket formed by a round top segment 400 that can be clamped to a bottom segment 402 by a pair of clamping bolts 404. Both segments 400, 402 of the clamping bracket include tongues 406 which join in a circle when the segments 400, 402 are bolted together, the tongues 406 having a radius and dimensions that fit closely within the support groove segments 304 of the adaptor module 401. The lower portion 402 of the clamping bracket includes an extension 410 in which a plurality of clearance holes 412 are included. In various embodiments, the sizes and the locations of the clearance holes or tapped holes included in extensions of clamping brackets comply with optical bench hole placement standards, such as the United States standard of ¼ inch×20 tapped or clearance holes spaced one inch apart, or the European standard of 6M tapped or clearance holes spaced 2.5 cm apart.

The adaptor module 401 of FIG. 4 can be used to adapt any conflat high vacuum assembly for support by clamping brackets 400, 402 of the present invention simply by attaching it to a convenient conflat port of the assembly. If desired, the adaptor module 401 can be inserted between two other UHV modules in the assembly.

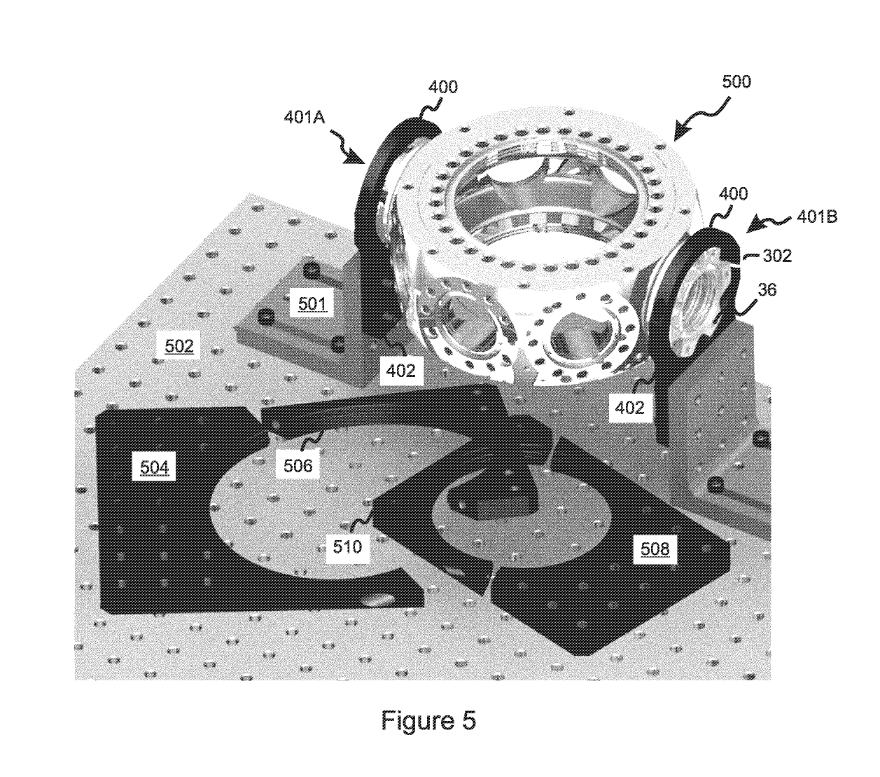

FIG. 5 is a perspective view of a UHV module 500 having two large conflat ports on its top and bottom, and eight smaller conflat ports arranged about its circular perimeter. Two UHV adaptor modules 401A, 401B of the type shown in FIG. 4 have been attached to two opposing smaller conflat ports, and clamping brackets 400, 402 have been attached to the supporting grooves of the UHV adaptor modules 401A, 401B. The clamping brackets 400, 402 are attached to an optical table 500 using standard optical bench accessory brackets 501, thereby providing mounting of the UHV module 500 to the optical table 502 with optical quality and rigidity. The orientation of the UHV module 500 about an axis passing through the centers of the two UHV adaptor modules can be arbitrarily adjusted simply by loosening the bolts 404 of the clamping brackets 400, 402 and rotating the UHV module 500. The figure also illustrates two other clamping bracket embodiments 504, 506, 508, 510, shown in two larger sizes.

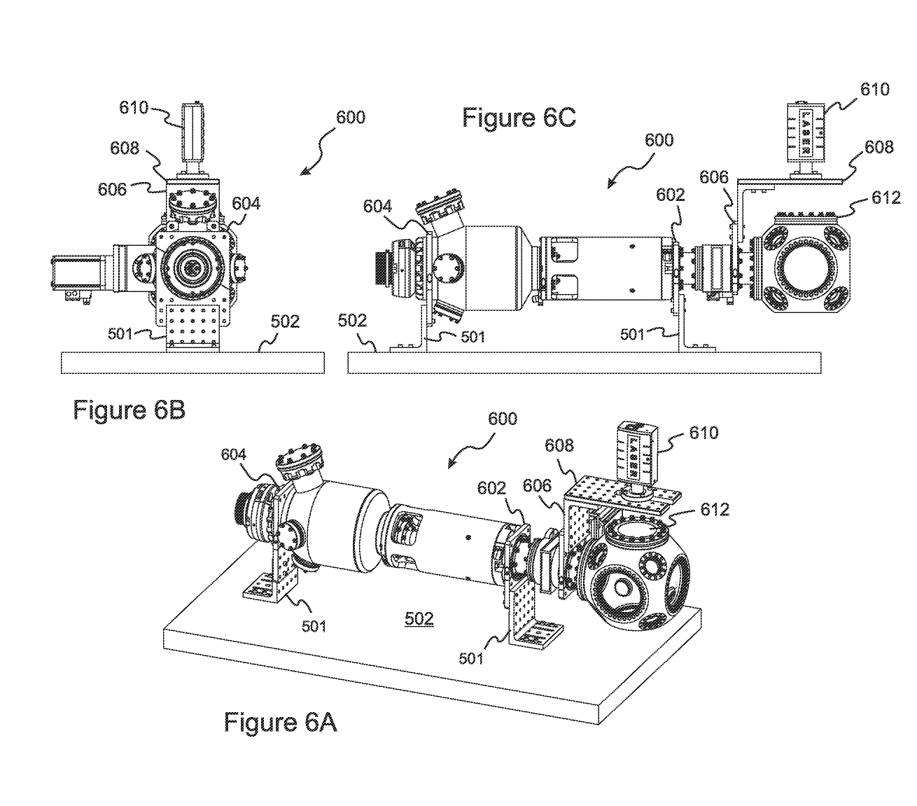

FIG. 6A is a perspective view of a UHV system 600 that comprises a plurality of UHV modules joined by conflat ports. The system 600 includes UHV modules of various shapes and sizes, but is nevertheless substantially linear in design, and requires support by at least two clamping brackets 602, 604, which are attached to the UHV system 600 by support grooves located adjacent to conflat flanges of two of the conflat ports, the clamping brackets 602, 604 being attached to an optical bench 502 by means of standard optical bench accessory brackets 501. If additional support is needed, additional clamping brackets can easily be attached to grooves that are provided adjacent to some of the other conflat ports. The clamping brackets 602, 604 are collinear, so that loosening of the conflat brackets 602, 604 allows the entire UHV system 600 to be rotated by an arbitrary angle about the common axis of the clamping brackets 602, 604.

In embodiments of the present invention, support grooves and clamping brackets are used not only for supporting a UHV system, but also for attaching other apparatus to the UHV system in a fixed relationship with the UHV system. The UHV system of FIG. 6A includes an additional clamping bracket 606 that is not needed for support of the UHV system 600 on the optical bench 502. Instead, this additional clamping bracket 606 is used to attach a LASER system 610 directly to the UHV system 600 by means of a standard optical bench accessory bracket 608, where the LASER 610 in FIG. 6A is positioned to direct a LASER beam into the UHV system 600 through an optical window 612 covering a conflat port located directly blow the LASER 610. FIG. 6B is an end view of the UHV system 600 of FIG. 6A, and FIG. 6C is a side view of the UHV system 600 of FIG. 6A.

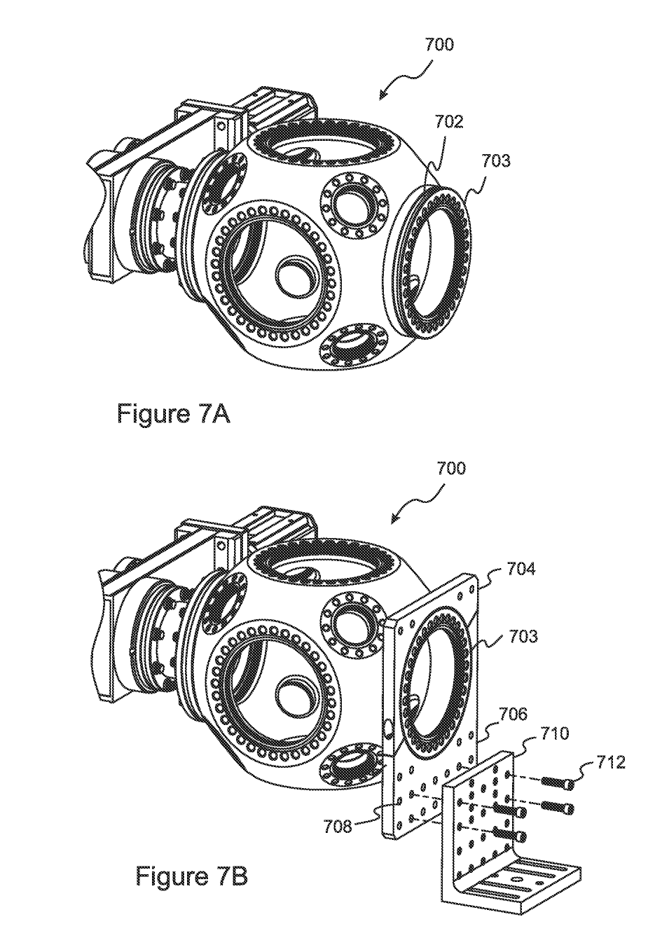

FIG. 7A is a perspective close up view of a UHV module 700 similar to one of the UHV modules of FIG. 6A, but including a groove 702 formed in a short extension of the UHV module 700 surrounding one of the conflat ports 703. FIG. 7B shows a clamping bracket 704 attached to the support groove 702 of FIG. 7A. The clamping bracket 704 includes an extension 706 in which a plurality of tapped holes 708 are provided that comply in both size and placement with an optical bench standard. A standard optical bench accessory bracket 710 can be attached to the extension 706 of the clamping bracket 704 by screws 712.

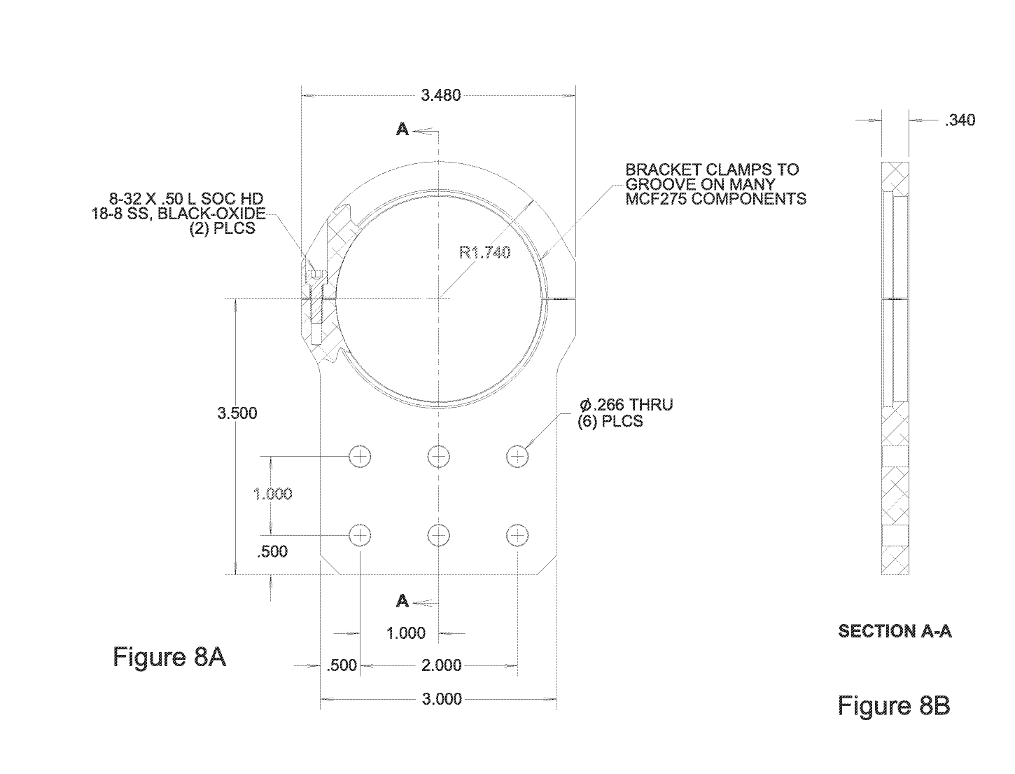

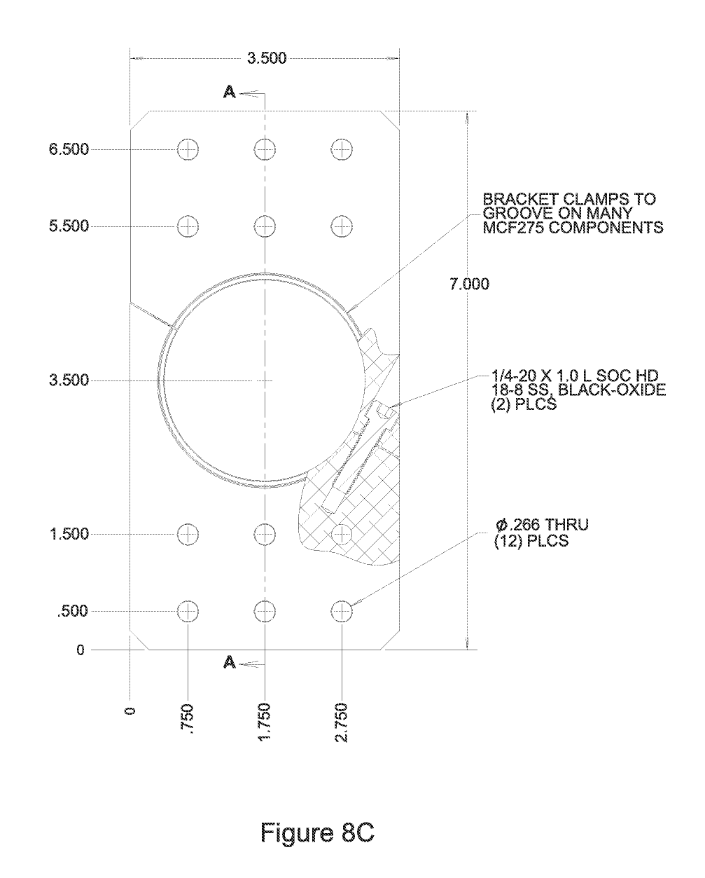

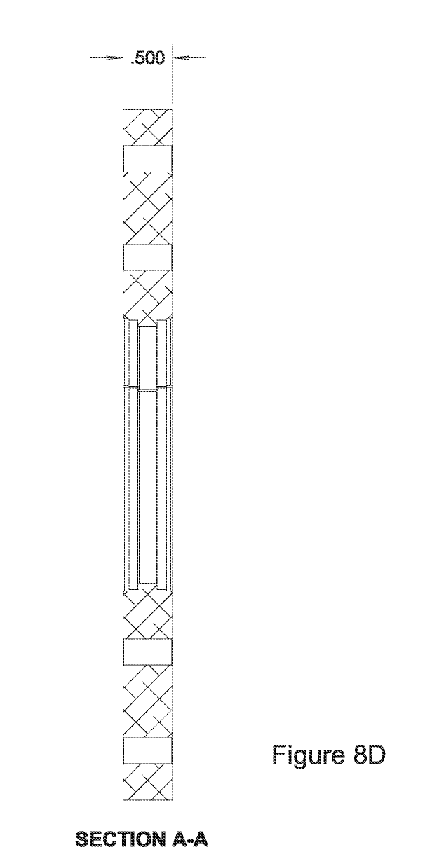

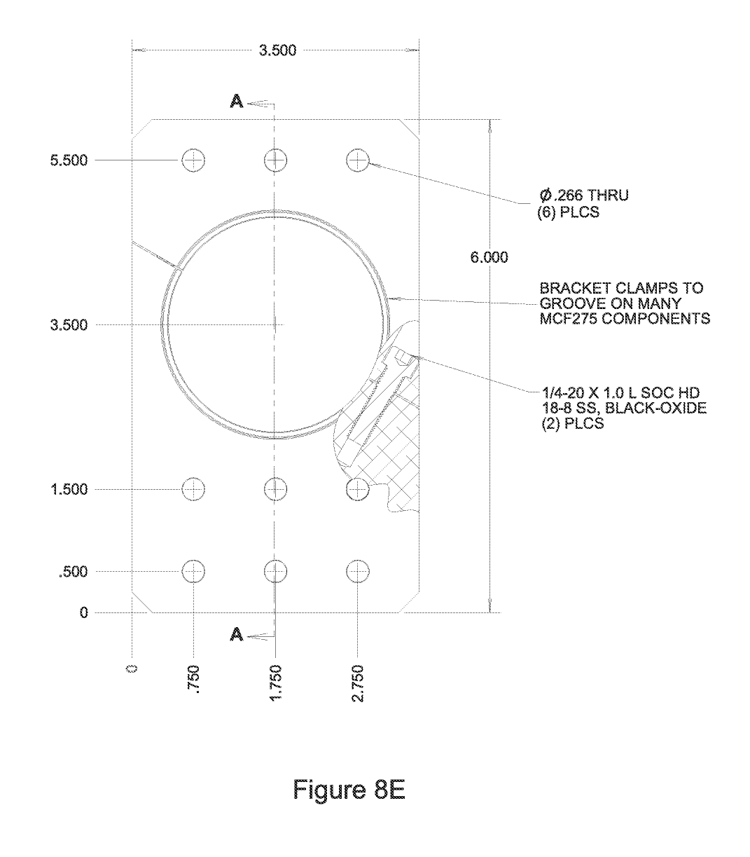

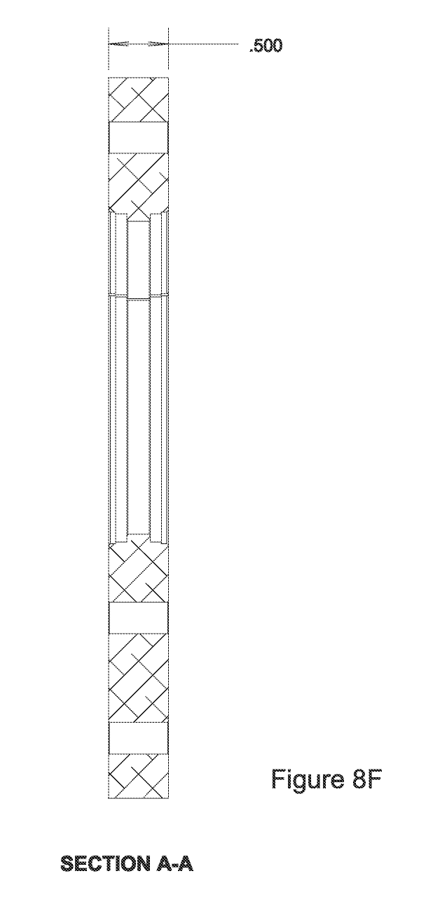

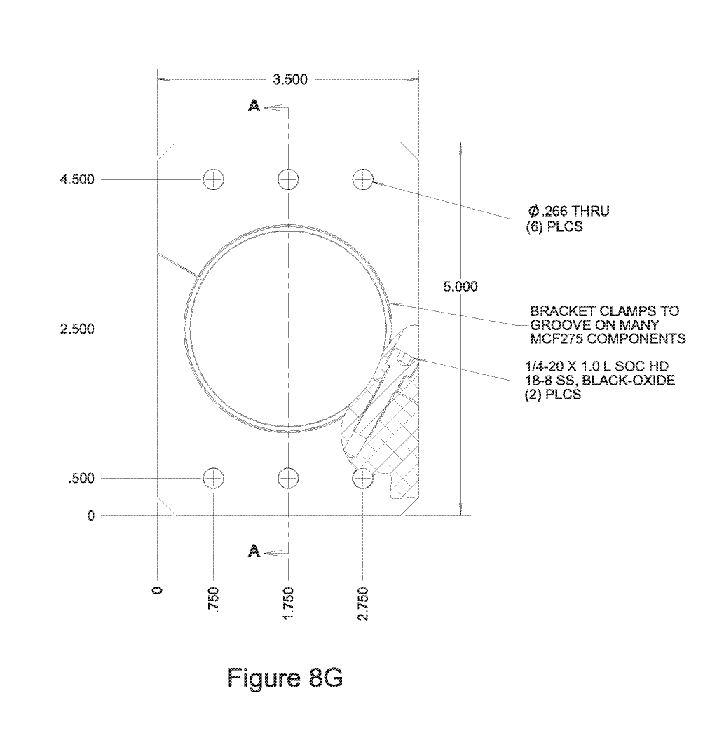

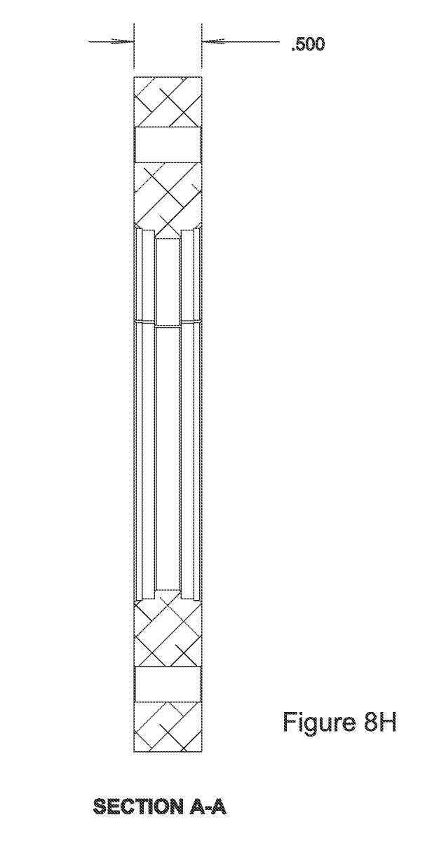

It should be clear to those skilled in the art that many different embodiments of clamping brackets are included in the present invention. FIGS. 8A and 8B present detailed front and side view scale drawings respectively of a mounting bracket embodiment similar to the mounting bracket 400, 402 of FIG. 4. FIGS. 8C and 8D, 8E and 8F, and 8G and 8H present detailed front and side view scale drawings respectively of three other embodiments of clamping brackets that are included in embodiments of the present invention.

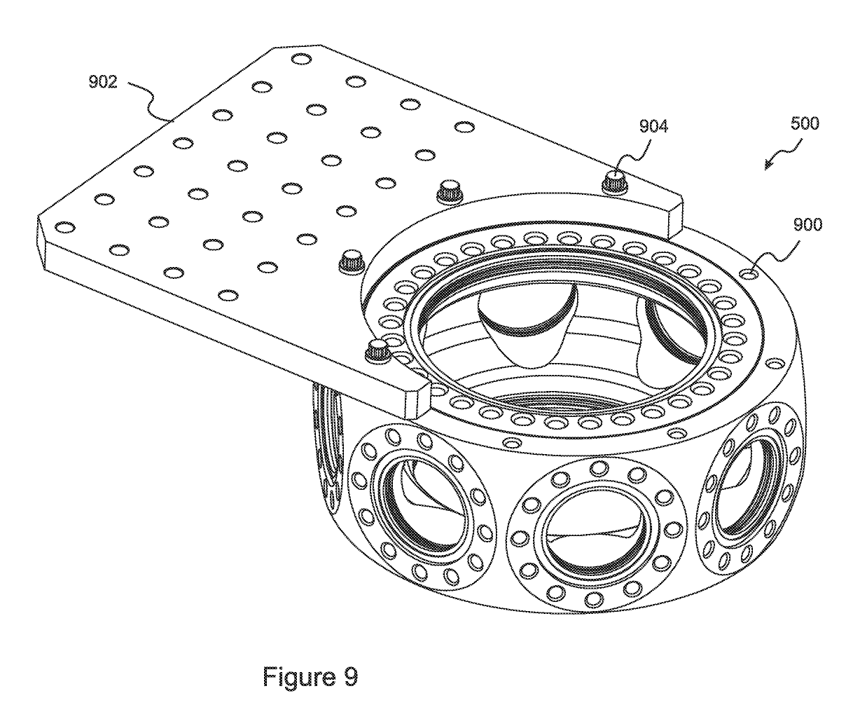

In another general aspect of the present invention, the mounting feature is a plurality of tapped mounting holes that are provided in the body of the UHV module, so that a mounting bracket can be bolted to the UHV module without using or obstructing any of the conflat ports. In embodiments, the mounting holes do not require enlargement of any dimensions of the UHV module. FIG. 9 is a perspective view of the UHV module 500 of FIG. 5. Note that the UHV module 500 includes eight tapped mounting holes 900, which are located in a circle on the top face of the UHV module 500 at a radius that is outside of the upper conflat port. The tapped mounting holes 900 are symmetrically located between adjacent pairs of the smaller conflat side ports. These locations are well removed from the bolt holes of the smaller conflat ports, so that no increase in any of the dimensions of the UHV module 500 is required.

A mounting bracket 902 has been bolted to four of the mounting holes 900 by mounting bolts 904. If needed, a second mounting bracket could be bolted to the other four mounting holes 900, so as to provide uniform support about the entire upper conflat port. Or a single mounting bracket could be provided that could be bolted to all eight of the mounting holes 900. Although not visible in the figure, it should be clear that symmetrically identical mounting holes 900 are provided in the bottom face of the UHV module 500 in FIG. 9.

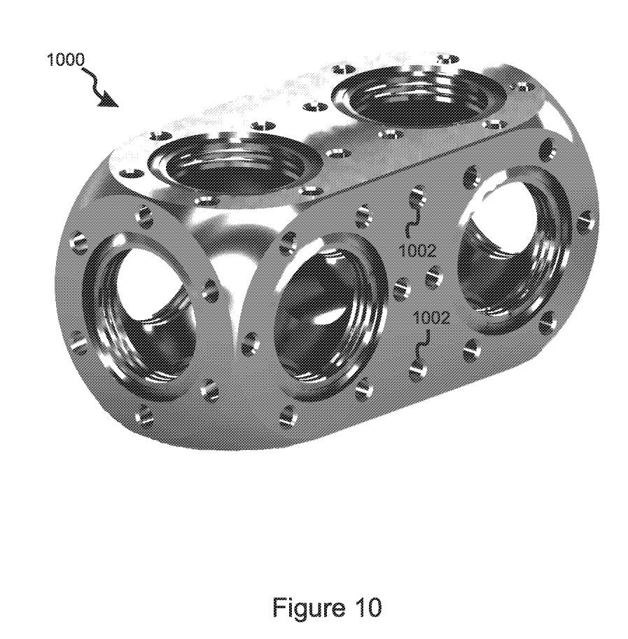

FIG. 10 is a perspective view of a UHV module 1000 that is formed in the shape of a pair of merged adjacent spheres. The UHV module 1000 includes two mounting holes 1002 located symmetrically between a pair of adjacent conflat ports on each side of the UHV module 1000. Although not visible in the figure, it should be apparent that an identical pair of mounting holes 1002 is provided on the opposite side of the UHV module 1000. Due to their locations, the mounting holes do not require enlargement of any dimensions of the UHV module 1000.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. An apparatus for supporting an assembly of ultra-high vacuum (UHV) modules joined by conflat joints between conflat ports, each UHV module including at least one conflat port formed in a body of the UHV module, the apparatus comprising:
a supporting feature included in at least one of the ultra-high vacuum modules at its time of manufacture; and
a mounting bracket that is attachable to the supporting feature,
the mounting bracket being attachable to and detachable from the supporting feature without loss of vacuum in the ultra-high vacuum modules, and
the mounting bracket being attachable to the support feature without obstructing any conflat port of the UHV module.

2. The apparatus of claim 1, wherein the supporting feature includes at least one groove formed in the UHV module, the at least one groove being shaped as at least an arc of a circle, the mounting bracket being a clamping bracket including a tongue that can be inserted into the at least one groove, the clamping bracket including at least two segments that can be clamped together when the tongue is in the groove so as to attach the clamping bracket to the UHV module.

3. The apparatus of claim 2, wherein the supporting feature is a single groove that is shaped as a complete circle.

4. The apparatus of claim 2, wherein the supporting feature is a plurality of grooves that are shaped and aligned as arcs of a single circle.

5. The apparatus of claim 2, wherein the clamping bracket can be loosened so as to allow the assembly of UHV modules to be continuously adjusted in angular orientation about the support feature.

6. The apparatus of claim 2, wherein the support feature is concentrically formed in a cylindrical extension that terminates in a conflat flange.

7. The apparatus of claim 2, wherein the support feature is formed in the body of the UHV module.

8. The apparatus of claim 2, wherein the circle of the at least one groove is symmetric about a conflat port of the UHV module.

9. The apparatus of claim 1, wherein the support feature is a plurality of tapped holes provided in the body of the UHV module.

10. The apparatus of claim 1, wherein the mounting bracket and support feature are capable of providing optical quality mounting of the UHV system to an optical bench.

11. The apparatus of claim 10, wherein the mounting bracket is penetrated by a plurality of holes arranged in a pattern that complies with either the optical bench standard of ¼×20 inch tapped or clearance holes spaced one inch apart or the optical bench standard of M6 tapped or clearance holes spaced 25 mm apart.

12. The apparatus of claim 1, wherein the support feature is formed in an adaptor UHV module that includes a pair of closely spaced, opposing conflat ports, the adaptor UHV module being attachable to a conflat port of a primary UHV module so as to enable support of the primary UHV module by the mounting bracket without reducing a total number of conflat ports available to the primary UHV module.

13. The apparatus of claim 12, wherein the support feature includes at least one groove formed in the adaptor UHV module, the at least one groove being shaped as at least an arc of a circle, the mounting bracket being a clamping bracket including a tongue that can be firmly inserted into the at least one groove, the clamping bracket including at least two segments that can be clamped together when the tongue is in the groove so as to firmly attach the clamping bracket to the UHV module.

14. The apparatus of claim 13, wherein the at least one groove is a plurality of grooves that are shaped and aligned as arcs of a single circle, the arcs being separated by gaps that provide access for mounting bolts to enter clearance holes in the adaptor UHV module so as to attach one of the closely spaced, opposing conflat ports of the adaptor UHV module to a conflat port of a first UHV module, the arcs being proximal to tapped holes suitable for attachment of the other of the closely spaced, opposing conflat ports of the adaptor UHV module to a conflat port of a second UHV module.

15. The apparatus of claim 1, wherein the mounting bracket and support feature are capable of attaching an accessory to the UHV system.

16. The apparatus of claim 15, wherein the mounting bracket provides optical quality mounting of the accessory to the UHV system.

17. The apparatus of claim 15, wherein the mounting bracket is able to attach a LASER to the UHV system, the LASER being aligned for transmitting light into the UHV system through one of the conflat ports of the UHV system.
